(19) United States
(12) Patent Application Publication
(10) Pub. No.: US 2024/0428066 A1
(43) Pub. Date: Dec. 26, 2024

(54) GLOBAL OPTIMIZATION FOR NEURAL NETWORK TRAINING

(71) Applicant: International Business Machines Corporation, Armonk, NY (US)

(72) Inventors: MALGORZATA JADWIGA ZIMON, Warrington (GB); Fausto Martelli, Stockton Heath (GB)

(21) Appl. No.: 18/214,188

(22) Filed: Jun. 26, 2023

(51) Int. Cl. G06N 3/08

(52) U.S. Cl. CPC G06N 3/08

(57) ABSTRACT

A data set is received for training a machine learning model to perform a recognition task. Optimization is performed during training of the machine learning model. The optimization includes at least searching for a minimum value of a loss function, responsive to finding a local minimum, adding an additional term to the loss function, continuing to find another local minimum until a criterion is met, and identifying a global minimum having the lowest minimum value among the found local minima. The machine learning model can be updated with parameters identified at the global minimum.

### BACKGROUND

The present application relates generally to computers and computer applications, and more particularly to machine learning, machine learning model training, neural network training optimization, global optimization in machine learning training and descent-based optimization of training for machine learning models.

### BRIEF SUMMARY

The summary of the disclosure is given to aid understanding of a computer system and method of machine learning training optimization, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In at least some embodiments, a computer-implemented method includes receiving a data set for training a machine learning model to perform a recognition task. The method also includes performing an optimization during training of the machine learning model, where the optimization includes at least: searching for a minimum value of a loss function, responsive to finding a local minimum, adding an additional term to the loss function and continuing to find another local minimum until a criterion is met, and identifying a global minimum having a lowest minimum value among the found local minima. The method also includes updating the machine learning model with parameters identified at the global minimum.

In at least some embodiments, a system includes at least one processor. The system also includes at least one memory device coupled with the at least one processor. The at least one processor is configured to receive a data set for training a machine learning model to perform a recognition task. The at least one processor is also configured to perform an optimization during training of the machine learning model, where the optimization includes at least: searching for a minimum value of a loss function, responsive to finding a local minimum, adding an additional term to the loss function and continuing to find another local minimum until a criterion is met, and identifying a global minimum having a lowest minimum value among the found local minima. The at least one processor is also configured to update the machine learning model with parameters identified at the global minimum.

A computer readable storage medium storing a program of instructions executable by a machine to perform one or more methods described herein is also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement machine learning training optimization in at least some embodiments.

FIGS. 2A-2D illustrate a snippet of a loss surface where global minimum can be found using a neural network training optimization in one embodiment.

FIGS. 3A-3C illustrate experimental results of a neural network training optimization in at least some embodiments.

FIG. 4 is a flow diagram illustrating an optimization method using local minimum filling for training a machine learning model in at least some embodiments.

FIG. 5 is another flow diagram illustrating another optimization method using local minimum filling for training a machine learning model in at least some embodiments.

FIG. 6 is a diagram showing components of a system in one embodiment that can perform machine learning, e.g., neural network, training optimization.

### DETAILED DESCRIPTION

In at least some embodiments, a computer-implemented method includes receiving a data set for training a machine learning model to perform a recognition task. The method also includes performing an optimization during training of the machine learning model, where the optimization includes at least: searching for a minimum value of a loss function, responsive to finding a local minimum, adding an additional term to the loss function and continuing to find another local minimum until a criterion is met, and identifying a global minimum having a lowest minimum value among the found local minima. The method also includes updating the machine learning model with parameters identified at the global minimum.

Advantageously, optimization to find more accurate parameters of a model being trained can continue, leading to improvement performance in trained models, for example, in a recognition system such as in medical applications, but not limited only to such applications. Metadynamic principles are harnessed to achieve a more efficient and quicker optimization of a system by more quickly and with fewer resources finding a global minimum for use as the basis of optimization for the machine learning training. The optimization is able to be performed on any network architecture to perform optimization of a machine learning model.

One or more of the following features are separable or optional from each other. For example, in an aspect, the machine learning model includes a deep neural network, and the optimization includes a descent-based optimization. In this way, for example, deep neural network training can be improved, e.g., leading to better performing neural networks in performing recognition tasks.

In another aspect, the additional term is a Gaussian bias centered around the local minimum. In this way, for example, the loss surface around the local minimum can be filled.

Yet in another aspect, the criterion includes a threshold number of local minima. In this way, e.g., by providing a predefined threshold number of searches for a local minimum, a training process in machine learning can be performed efficiently.

Still yet in another aspect, the additional term is added to the loss function until the local minimum is filled. For example, local landscape can be changed such that the search does not return to the same site of the loss surface.

Still further in another aspect, the method can include storing the additional terms. Yet in another aspect, the method includes reconstructing an original landscape of the loss function by accessing the stored additional term and subtracting the added additional terms. The ability to restore the original loss surface can help in applications that refer back to the original loss.

In another aspect, multiple instances of the optimization are performed in parallel at different initialization points of a loss surface of the loss function. In this way, e.g., search for a global minimum can be accelerated.

Yet in another aspect, the method also includes using the updated machine learning model in performing a recognition task. Using the updated machine learning model, e.g., trained to have better performing parameters, can provide performance improvements in recognition tasks.

A system including at least one computer processor and at least one memory device coupled with the at least one computer processor is provided, where the at least one computer processor is configured to perform one or more methods described herein. A computer program product that includes a computer readable storage medium having program instructions embodied therewith, the program instructions readable by a computer to cause the computer to perform one or more methods described herein is also provided.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine learning training optimization algorithm code 200. In addition to machine learning training optimization algorithm code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and machine learning training optimization algorithm code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

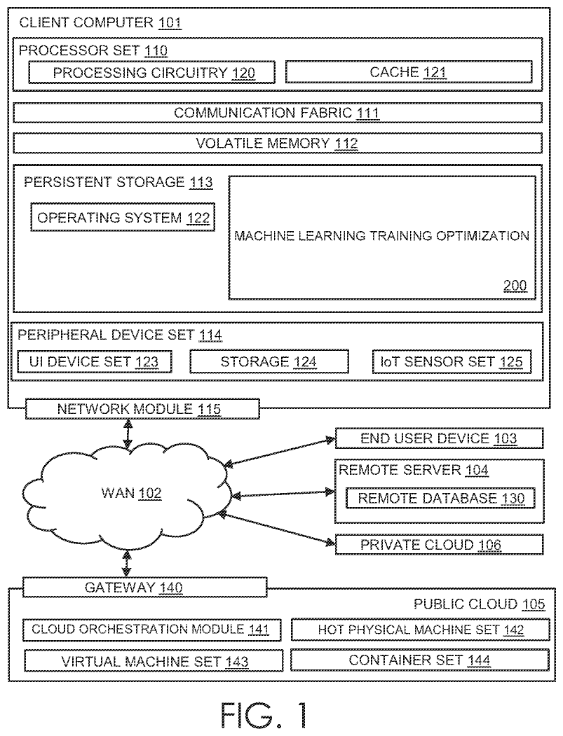

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in machine learning training optimization algorithm code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in machine learning training optimization algorithm code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Deep neural networks are a class of machine learning algorithms based on the artificial neural network and include a plurality of hidden layers between input and output layers. Artificial neural network is also referred to as neural network herein. During training deep neural networks or neural networks that use descent-based algorithms, a goal is to find a minimum where the training can stop and provide a well-trained model that can accurately provide recognition and/or prediction for their respective applications. Descent-based algorithms aim to minimize or optimize a loss function. A loss function informs the cost or error between the machine learning model's prediction and the expected value. For example, the loss function tells how well or not well the machine learning model has performed its task.

Gradient descent is an example of a descent-based algorithm and is an iterative approach for locating a function's minima. This descent-based algorithm is an optimization technique for locating the parameters or coefficients of a function with the lowest value, e.g., where the function has a minimum value. The algorithm, however, does not always discover a global minimum and can become trapped at a local minimum. A global minimum is the function's lowest value, whereas a local minimum is the function's lowest value in a specific neighborhood.

Finding a global minimum among local minima on a loss surface, however, can be challenging. For example, there can be tasks where the global optimum is far away from local minima and its identification requires a detailed exploration of the loss surface. For instance, in the past the only method guaranteed to find the global minimum of an optimization problem was a complete search of the parameter space.

In one or more embodiments, systems, methods and/or techniques are disclosed that can provide a protocol for enabling optimization algorithms, e.g., descent-based algorithms, in machine learning such as in neural network training to explore the loss surface in search of the global optimum and/or its approximation based on a pre-defined threshold. In at least some embodiments, a descent-based optimization process for training of recognition systems can be enriched by the approach of Gaussian filling of the loss surface. A computer-implemented method, for example, can add a penalty term (e.g., Gaussian bias) to the loss when a local minimum is reached to encourage the optimization process to explore other regions of the parameter space. For instance, when the optimization procedure reaches a local minimum, a Gaussian bias can be added to the loss function. The Gaussian biases can be added until the local minimum is filled, and the optimization procedure can be continued. In this way, for instance, the descent-based algorithm can be discouraged to come back to the previous point or local minima, and it can allow for improved identification of the global minimum. In an aspect, this can be beneficial for recognition systems used in rare event identification, medical applications, risk analysis, and/or in other technical applications. For example, improved identification of the global minimum results in trained neural network models that can accurately perform their functions, e.g., recognitions and/or predictions, improving the overall performance of the neural network models. Another benefit of the neural network training optimization disclosed herein can be that the optimization technique allows the training to reach the global minimum faster, thus speeding up the neural network training process. In this way, computer processor run time and memory space can be utilized more efficiently.

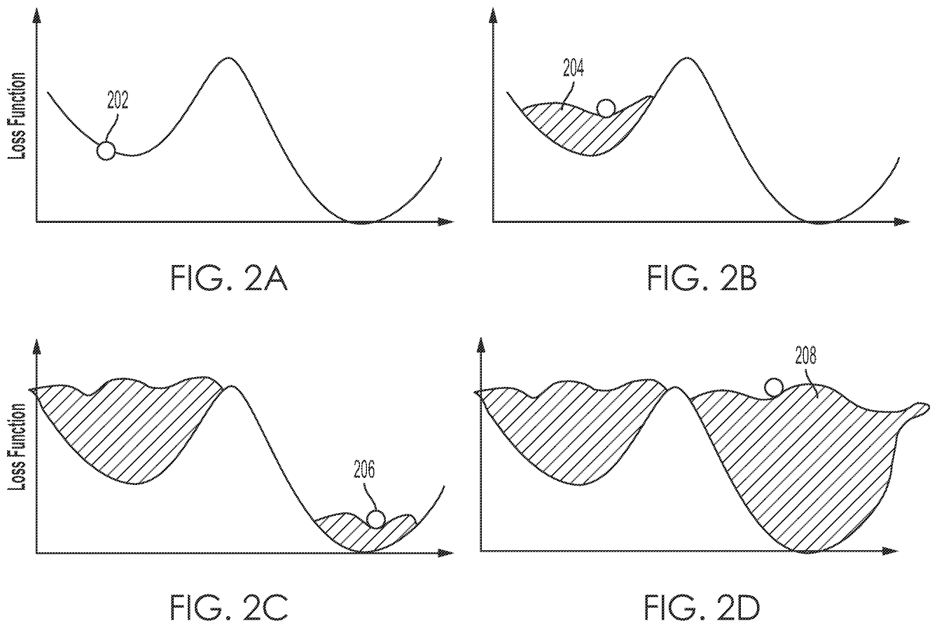

FIGS. 2A-2D illustrate a snippet of a loss surface where global minimum can be found using a neural network training optimization in one embodiment. In the figures, the y-axis represents a loss function, the x-axis represents a parameter space, the curve represents a loss space. The snippet terminology refers to the loss surface extending further rightwards and/or leftwards outside of the view of the depicted graphs, but the snippet portion is shown to illustrate the concept of navigating around various minima identified according to the present disclosure. In FIG. 2A, a descent-based algorithm during neural network training identifies a local minimum 202. For example, the descent-based algorithm finds a minimum loss, for example, not aware that the identified minimum loss may be a local minimum and that there could be a global minimum elsewhere in the loss space that is greater than the other local minimum. If no other processing is performed, the algorithm may get trapped in this local minimum. In FIG. 2B, the neural network training optimization described herein in one or more embodiments can fill the loss space with a penalty term, e.g., Gaussian bias 204, such that the descent-based algorithm no longer recognizes this region as a minimum value and continues with further exploration to search for another minimum value which could be the global minimum. In FIG. 2C, the descent-base algorithm finds another minimum and initially performs an epoch that adds a first Gaussian at the newly found minimum. After adding the first Gaussian, the curve or loss space produces a first modified minimum 206. However, this first modified minimum still represents a local minimum for the overall curve as indicated by the continued concave area above the first modified minimum 206. Thus, the optimization upon sensing that the minimum and concavity still exist performs one or more additional epochs that add additional one or more Gaussians until the entire concave area is filled as shown in FIG. 2D. In FIG. 2D, the neural network training optimization in one or more embodiments can fill the loss space with a sum of multiple Gaussian biases 208 in search of global optimization or global minimum in this example.

In some embodiments, an objective function f, i.e., the function to be minimized, can be a function of the difference between the observed data values (e.g., actual values) and the predicted model of the regular peaks (predicted values). By way of example, this may be as simple as the sum of the absolute differences (or, e.g., mean absolute error (MAE), which is the average absolute error between actual and predicted values). Another example can be a mean squared error (MSE), which is the average squared error between actual and predicted values.

In some embodiments, during, e.g., gradient descent, the algorithm iteratively calculates the next point using gradient at the current position, pₙ, scales the gradient (by a learning rate, η) and subtracts the obtained value from the current position (makes a step) to move toward the local minimum. This process can be written as pₙ₊₁=pₙ−η∇f(pₙ). The algorithm can start with an initial value, which can be a random value or another initial value, p₀ for a local minimum of f, and consider the sequence p₀, p₁, p₂, . . . for n epochs until a convergence is met. For example, convergence can be met when the gradient approaches a single value, e.g., such as close to zero, or some threshold. The learning rate f which scales the gradient can influence the performance. Epoch herein refers to an iteration or a step taken (a move) during a descent algorithm in search of a minimum of the loss function.

To enhance the system sampling and enable global optimization by discouraging revisiting of sampled states (and local minima), the neural network training optimization in at least some embodiments adds a penalty term, e.g., a bias, to the loss function, f, when the algorithm approaches a minimum, \hat{p}, i.e., ∇f is small, e.g., below a threshold. The threshold can be predefined or given. It should be noted that this bias that is being added to the loss function is separate from a neural network bias, as in neural network weights and bias.

In some embodiments, for a one dimensional problem, the bias that is added takes a form of one-dimensional Gaussian, where

$$bias = {\sum }_{n}^{{n}_{m}} ω exp ( - \frac{1}{2} {\vert \frac{{p}_{n} - \hat{p}}{σ} \vert}^{2} ) ,$$

where σ defines its spread, a (which can be chosen a priori or given) re-weights the determination and n is the n-th epoch. The notation “exp” represents an exponential function. A biasing function is also referred to as a “kernel”, e.g., a Gaussian function used for biasing. Position on the loss surface at the n-th epoch, pₙ, is being “filled” with Gaussians nₘ−n times. The closer pₙ is to the local minimum, the more bias is being added to the loss surface. When the biasing is initiated, pₙ=\hat{p}. Final iteration nₘ denotes the last epoch at which the Gaussians are added to the location \hat{p}. It (nₘ) can be pre-defined a priori, or it can be updated based on the size of the gradient, ∇f. For example, nₘ can be adaptively increased until the gradient has a higher value than a threshold (e.g., a fill threshold).

In at least some embodiments, the kernel can be a multi-dimensional function when a high-dimensional surface is to be optimized. The Gaussians are being added n−nₘ times to ensure that the local minimum, \hat{p}, is filled. In at least some embodiments, the filling can stop when the gradient increases above a threshold (a fill threshold), which can be pre-defined. In some embodiments, the filling stops when the gradient decreases below a threshold, e.g., when the value of the downward slope of the loss function approaches zero. The bias is added to the loss function to ensure that the site will not be re-visited. At this point, the loss landscape can be recovered as the opposite of the sum of all Gaussians so that by subtracting a stored Gaussian value the original value is reconstructed.

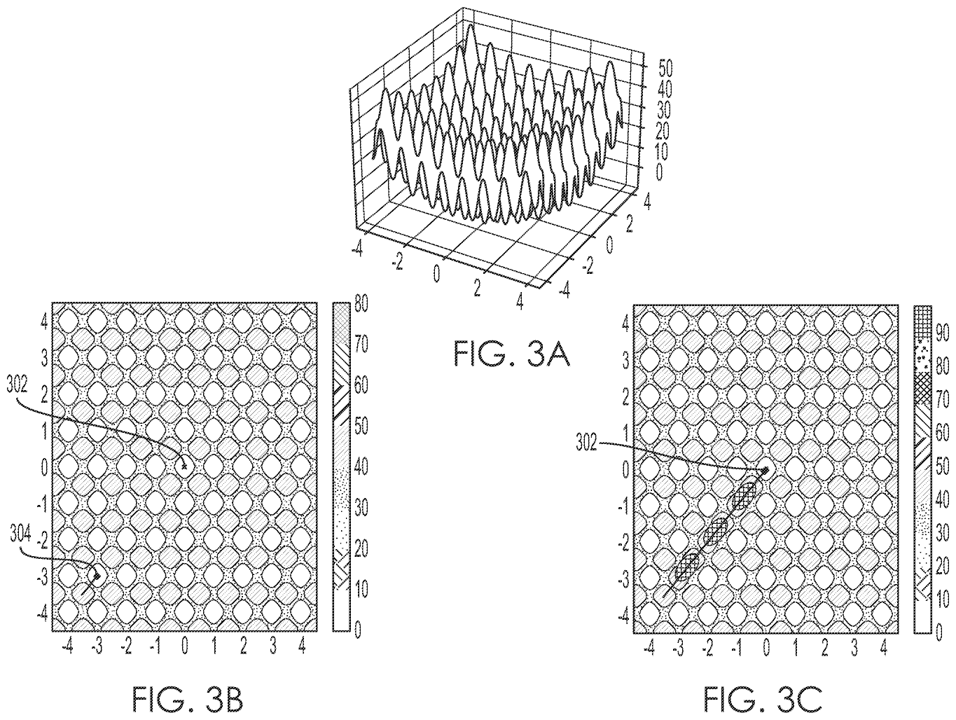

FIGS. 3A-3C illustrate experimental results of a neural network training optimization in at least some embodiments. FIG. 3A illustrates a loss surface of a non-convex function, commonly adopted as a performance test problem for optimization algorithms. The 3-dimensional surface shows peaks and valleys where there are multiple local minima and a global minimum. FIGS. 3B and 3C illustrate 2-dimensional top views of the loss function shown in FIG. 3A, where the unshaded areas represent valleys (minima) of various depth and shaded areas represent peaks of various heights. By way of example, consider that the global minimum (e.g., the steepest valley on the loss surface) exists at the cross mark shown at 302. In the experiment, it is observed that gradient descent gets trapped in the first local minimum 304 after 5,000 iterations. For instance, in FIG. 3B, optimization steps of gradient descent, starting from (−3.5, −3.5) ends at a diamond mark shown at 304, in search of the global minimum at (0, 0). With the approach described herein, e.g., optimization steps of gradient descent with an added penalty term (e.g., Gaussian), however, it is observed that the optimization reaches the global minimum 302 with 11 iterations. Referring to FIG. 3C, optimization steps of gradient descent with added bias (showing valleys filled in) starting from (−3.5, −3.5) in search of the global minimum at (0, 0) reaches that global minimum 302. The figure also shows the change in the loss landscape due to added bias or Gaussians (e.g., the filled-in valleys). In the experiment, learning rate was set to 0.001. Other learning rates can be used.

The algorithm disclosed herein allows, e.g., a processor, to explore the loss landscape efficiently. For instance, adding biasing improves space exploration. In at least some embodiments, a stopping criterion can be provided. For example, after N number of minima is identified, one that is the deepest among the N can be chosen. N can be preconfigured or given. In at least some embodiments, the landscape can be recovered at any time by storing the biases that were added and removing or subtracting them from the original loss function.

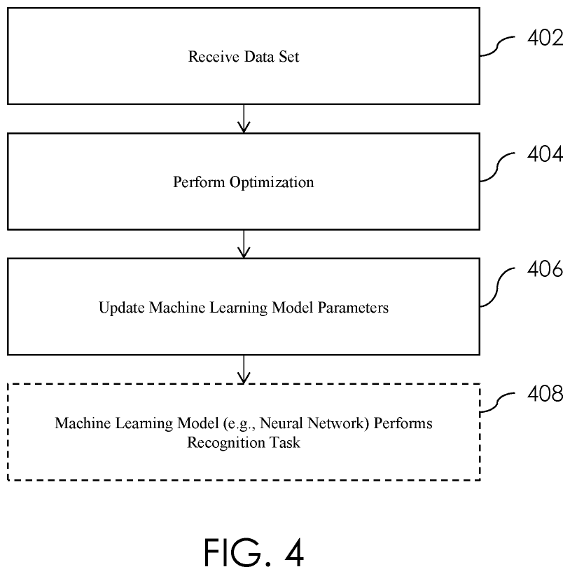

FIG. 4 is a flow diagram illustrating a method for optimization using local minimum filling according to at least some embodiments. The method enables optimizations such as descent-based algorithms in machine learning such as neural network training to explore the loss surface in search of the global minimum. For example, a protocol for global optimization in neural network training for recognition systems can be provided. While the description herein refers to neural network training, the method can be used for training other machine learning architectures where optimization such as a descent-based algorithm can be used. An example is a regression model. Further, while the description herein refers to gradient descent-based optimization algorithms, other variants of optimization algorithms, such as alternating minimization, stochastic gradient descent, block coordinate descent, back-propagation, and quasi-Newton methods can be used. Further, filling of the loss surface with an additional term (e.g., Gaussian bias) can be applicable to other machine learning optimizations where decisions are made based on a parameter value other than a gradient.

At 402, the method includes receiving a data set for training a machine learning model to perform a recognition task. The data set can include input-output pairs such that supervised learning can be performed. For example, the output data corresponding to the input data can be used as the actual value or expected value, in computing a loss function during training optimization, where the predicted value generated from the machine learning model is compared with the actual value. In some embodiments, the machine learning model can be a deep neural network. In some embodiments, the recognition task can include tasks that identify images such medical images, tasks that recognize cell structures, and/or others.

At 404, the method also includes performing an optimization such as a descent-based optimization during training of the machine learning model. An example of the descent-based optimization includes gradient descent algorithm and/or variations thereof. Other optimizations can also apply. The optimization includes searches for a minimum value of a loss function used in the optimization. During training, responsive to finding a local minimum, the method includes adding an additional term to the loss function and continuing the optimization process to find another local minimum until a criterion is met. For example, the searches more local minima continues until a criterion is met. In at least some embodiments, the additional term can be a Gaussian bias centered around the local minimum. In at least some embodiments, the additional term is added to the loss function until the local minimum is filled. In that way, the optimization algorithm can move on with its optimization and does not visit this local minimum again. Data associated with the local minimum can be stored for later reference. In at least some embodiments, the criterion can be finding a threshold number of local minima, e.g., a predefined threshold number of local minima have been identified. Among a plurality of local minima identified during this optimization, the one with the lowest minimum value can be identified as a global minimum.

At 406, the method includes updating the machine learning model with parameters identified at the global minimum. For instance, the parameters associated with the lowest loss function value can be used as the machine learning model parameters.

Beneficially, the method can allow exploring a loss surface or landscape efficiently and can find a global minimum among local minima in a loss surface of a loss function, leading to more performance enhanced trained machine learning models. In an aspect, the method need not have a priori knowledge of the loss function's landscape in finding a global minimum.

In at least some embodiments, the method can also include storing the additional terms. For example, information about how many additional terms were used to fill the local minimum space and/or the values of those additional terms can be stored. In this way, for example, an original landscape of the loss function can be reconstructed by removing, e.g., subtracting the added additional terms. The ability to recover the original landscape can be beneficial, e.g., for applications that need information about the original structure.

In at least some embodiments, multiple instances of the optimization can be performed in parallel at different initialization points of a loss surface of the loss function. For example, different parts of the loss surface are explored simultaneously or in parallel, which can accelerate the training process of finding the global minimum and thereby an optimal solution. In this way, for example, training can be accelerated and also leads to building a performance enhanced model faster for the model to perform its recognition task.

At 408, the method also includes using the updated machine learning model in performing a recognition task. E.g., the machine learning model, e.g., neural network, performs a recognition task. Beneficially, the trained machine learning model may be able to solve complex recognition tasks or problems.

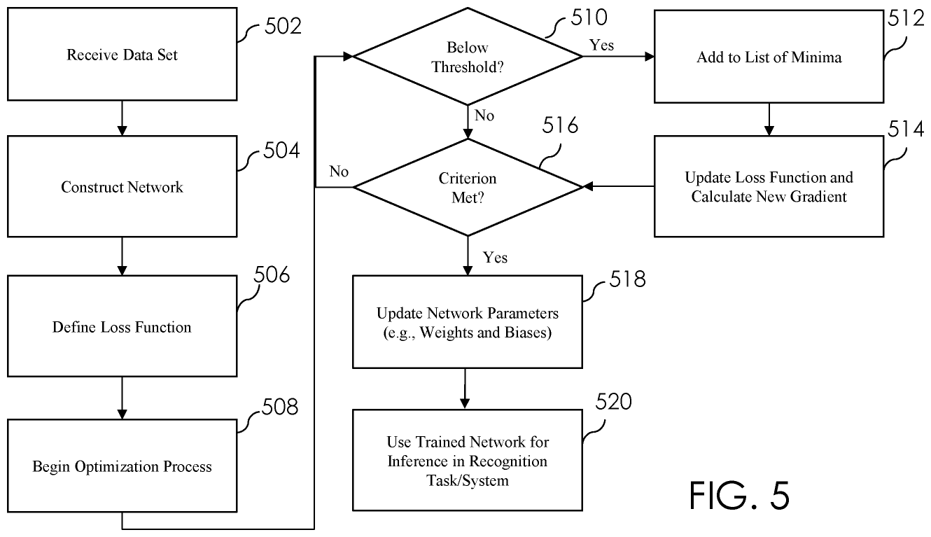

FIG. 5 is another flow diagram illustrating a method for filling a local minimum to perform optimization according to at least some embodiments. The method illustrates neural network training, for example, for recognition systems, using a protocol of adding a bias term to a loss function in search of the global optimum, such that optimal parameters for the neural network can be identified. Here, the optimization strategy is based on gradient descent. However, it should be understood that any optimization approach can be used. The method can be performed or implemented on one or more computer processors.

At 502, a processor collects or receives a data set of input-output pairs, where the outputs are recognition labels associated with a recognition task.

At 504, a processor constructs a network. For instance, a machine learning architecture can be chosen that is suitable for the recognition task. An example is a neural network or a deep neural network.

At 506, a processor defines a loss function that, given the values of centers of local minima, \hat{p}, scales ω, standard deviation σ, adds a bias. Scales ω and standard deviation a can be pre-defined. The standard deviation can be a function of a learning rate. The learning rate is another hyperparameter that can be set before the training and stay fixed or can change adaptively during training. Local minima, \hat{p}, can be searched for and found during the optimization process and stored in memory. An example loss function can be the Mean Squared Error (MSE), e.g.,

$$loss function = \frac{1}{total \# of samples} \sum {( actual - predicted )}^{2} ,$$

the difference between the actual and the predicted value of each sample, and then dividing it by the number of samples. Other loss functions can be used to build the loss function.

At 508, a processor begins the optimization process using the loss function. In at least some embodiments, bias is added only when the local minimum is identified. For example, the loss function with a bias can have zero scale unless the local minimum is reached. At each step of the optimization process, a processor can calculate gradients of the loss function. For example, for each parameter in the loss function, a gradient of the loss function can be calculated respect to that parameter.

At 510, if the gradients cross, e.g., fall below, a threshold value, a processor identifies the current position as a local minimum and adds the identified current position for this minimum to a list of minima at 512. The list of minima contains all the local minima that are identified during the optimization.

At 514, based on the presence of the minimum, a processor updates the loss function and calculates new gradients. For example, the loss function at the position identified at 510 and 512, can be updated by adding an additional term (also referred to as a penalty term or a bias). The additional term (penalty term or bias) can be a Gaussian bias. For example, when a minimum is identified, a processor can make the scale (omega (w)) of the loss term nonzero. In this way, the bias can be added. In at least some embodiments, the bias is added to the loss function and the position p is updated based on the gradient of the loss. In an aspect, this changes the loss landscape. It should be noted that the bias added to the loss function is separate from the neural network bias.

Optimization continues until the loss space is explored in a satisfactory manner, e.g., among all the minima identified, there is one that offers a relatively lower loss value than others, which would be designated as a global minimum. For example, at 516, it is determined whether a criterion is met. An example of the criterion is that a threshold number of local minima has been found. For example, the loss space has been explored sufficiently such that a pre-defined N number of local minima has been found, for instance, where a global minimum can be identified among the local minima found. If the criterion has been met, the method proceeds to 518. Otherwise, the method continues to 510, where a determination as to whether the new gradient calculated at 514 is below the threshold value, such that the position of that new gradient can be identified as another local minimum.

At 518, a processor updates the weights and biases of the neural network based on the global minimum identified.

At 520, the trained neural network is used for the recognition task.

In another embodiment, the processor automatically adds an additional Gaussian bias (with a different scaling parameter) directly to the step pₙ₊₁ to enable the optimization search to “jump” away from the minimum. For example, this direct addition to the step pₙ₊₁ (e.g., step after p) simply moves the current position slightly away from the minimum, e.g., without changing the loss surface or landscape topology. This can speed up the exploration. This jump is performed in addition to or alternatively to the loss addition to fill the area around the local minimum.

In at least some embodiments, the processor automatically runs multiple optimizations, for example, simultaneously or in parallel, with different starting points. This technique helps achieve efficient parallel training.

The method disclosed herein can accelerate the training of machine learning models.

In at least some embodiments, in the presence of local minima, a processor adds Gaussians (the additional term) in the area of small gradients to continue the loss surface exploration. Adding Gaussians in the neighborhood with small gradients allows the optimization process to not only tackle saddle points but also local minima. It also provides a way to easily reconstruct the uncovered loss surface. For instance, the added additional term can be removed, e.g., subtracted at the position to reconstruct the original loss surface.

A system and method can enable descent-based algorithms, e.g., in neural network training or another machine learning training, to explore the loss surface in search of the global optimum. An additional term (referred to herein also as a penalty term, a bias, a Gaussian, a Gaussian bias) can be added the loss when a local minimum is reached to encourage the optimization process to explore other regions of the parameter space. For instance, when the optimization procedure reaches a local minimum, a Gaussian bias can be added to the loss function. The Gaussians can be added until the local minimum is filled, and the optimization procedure can be continued. In the additional term, the Gaussian can be centered around the local minimum, and the standard deviation or the spread (a) can be related to (a function of) the learning rate. In another aspect, the standard deviation or the spread in the additional term can be determined using an estimate of the Hessian of the loss.

In some instances, the loss landscape can change during optimization, which can prevent revisiting known local minima. In at least some embodiments, the loss landscape can be recovered at any point as the opposite of the addition of all Gaussians, e.g., the sum of all Gaussians, by removing, e.g., subtracting the added terms. Multiple independent optimizations (e.g., starting from a different point on the loss surface) can be launched to uncover parts of the loss landscape.

Trained machine learning models such as neural network models trained using the local minimum filling as described herein can be used in recognition systems or tasks, such as but not limited to, medical applications and risk analysis. Another example of a use case can be in observing low energy configuration when designing raw material.

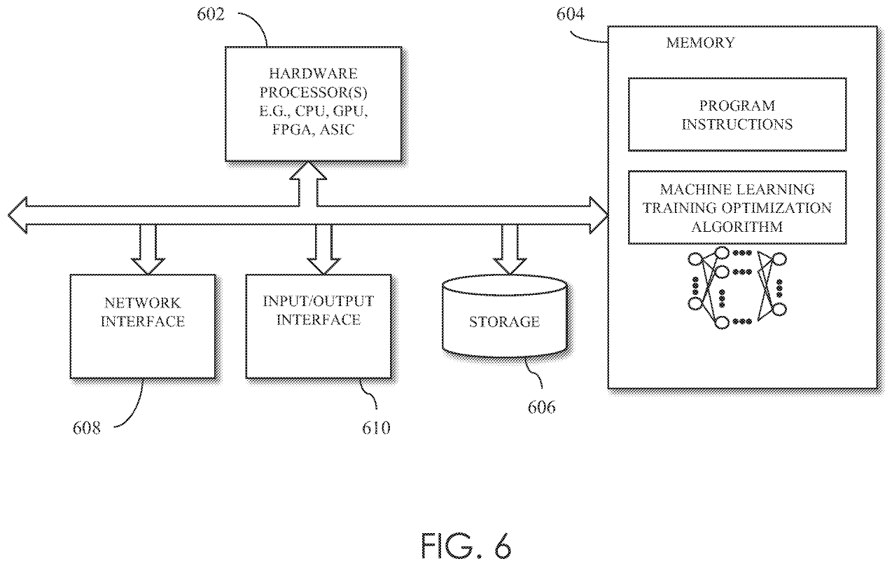

FIG. 6 is a diagram showing components of a system in one embodiment that can perform machine learning, e.g., neural network, training optimization. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and train a neural network to perform a recognition task. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602 and may include an operating system and other program of instructions and/or data. One or more hardware processors 602 may receive a data set for training a machine learning model to perform a recognition task. One or more hardware processors 602 may perform an optimization such as a descent-based optimization during training of the machine learning model. The optimization can include at least searching for a minimum value of a loss function, e.g., where the loss function is one used in the optimization, where responsive to finding a local minimum, adding an additional term to the loss function, continuing to find another local minimum until a criterion is met, and identifying a global minimum having a lowest minimum value among the found local minima. One or more hardware processors 602 may update the machine learning model with parameters identified at the global minimum. In an aspect, the data set may be stored in a storage device 606 or received via a network interface 608 from a remote device, and may be temporarily loaded into a memory device 604 for training the machine learning model. The learned machine learning model, e.g., neural network, may be stored on a memory device 604, for example, for running or use in inference by one or more hardware processors 602. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in at least some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving a data set for training a machine learning model to perform a recognition task;
performing an optimization during training of the machine learning model, wherein the optimization comprises at least:
searching for a minimum value of a loss function;
responsive to finding a local minimum, adding an additional term to the loss function and continuing to find another local minimum until a criterion is met; and
identifying a global minimum having a lowest minimum value among the found local minima; and
updating the machine learning model with parameters identified at the global minimum.

2. The computer-implemented method of claim 1, wherein the machine learning model includes a deep neural network and the optimization includes a descent-based optimization.

3. The computer-implemented method of claim 1, wherein the additional term is a Gaussian bias centered around the local minimum.

4. The computer-implemented method of claim 1, wherein the criterion includes a threshold number of local minima.

5. The computer-implemented method of claim 1, wherein the additional term is added to the loss function until the local minimum is filled.

6. The computer-implemented method of claim 1, wherein the method further includes storing the additional term.

7. The computer-implemented method of claim 6, further comprising reconstructing an original landscape of the loss function by accessing the stored additional term and subtracting the added additional term.

8. The computer-implemented method of claim 1, wherein multiple instances of the optimization are performed in parallel at different initialization points of a loss surface of the loss function.

9. The computer-implemented method of claim 1, further comprising using the updated machine learning model in performing a recognition task.

10. A computer program product comprising a computer readable storage medium having program instructions embodied therewith, the program instructions readable by a computer to cause the computer to:
receive a data set for training a machine learning model to perform a recognition task;
perform an optimization during training of the machine learning model, wherein the optimization comprises at least:
searching for a minimum value of a loss function;
responsive to finding a local minimum, adding an additional term to the loss function and continuing to find another local minimum until a criterion is met; and
identifying a global minimum having a lowest minimum value among the found local minima; and
update the machine learning model with parameters identified at the global minimum.

11. The computer program product of claim 10, wherein the machine learning model includes a deep neural network and the optimization includes a descent-based optimization.

12. The computer program product of claim 10, wherein the additional term is a Gaussian bias centered around the local minimum.

13. The computer program product of claim 10, wherein the criterion includes a threshold number of local minima.

14. The computer program product of claim 10, wherein the additional term is added to the loss function until the local minimum is filled.

15. The computer program product of claim 10, wherein the computer is further caused to store the additional terms.

16. The computer program product of claim 10, wherein multiple instances of the optimization are performed in parallel at different initialization points of a loss surface of the loss function.

17. The computer program product of claim 10, wherein the computer is further caused to use the updated machine learning model in performing a recognition task.

18. A system comprising:
at least one processor;
at least one memory device coupled with the at least one processor;
the at least one processor configured to at least:
receive a data set for training a machine learning model to perform a recognition task;
perform an optimization during training of the machine learning model, wherein the optimization comprises at least:
searching for a minimum value of a loss function;
responsive to finding a local minimum, adding an additional term to the loss function and continuing to find another local minimum until a criterion is met; and
identifying a global minimum having a lowest minimum value among the found local minima; and
update the machine learning model with parameters identified at the global minimum.

19. The system of claim 18, wherein the machine learning model includes a deep neural network and the optimization includes a descent-based optimization.

20. The system of claim 18, wherein the additional term is a Gaussian bias centered around the local minimum.
